(19) United States
(12) Patent Application Publication
(10) Pub. No.: US 2015/0220128 A1
(43) Pub. Date: Aug. 6, 2015

(54) Method and Apparatus for Use in a Data Processing System

(71) Applicant: Infineon Technologies AG, Neubiberg (DE)

(72) Inventors: Jens Barrenscheen, Munich (DE); Prakash Kalanjeri Balasubramanian, Bangalore (IN)

(21) Appl. No.: 14/171,837

(22) Filed: Feb. 4, 2014

(51) Int. Cl. G06F 1/32

(52) U.S. Cl. CPC G06F 1/324

(57) ABSTRACT

Disclosed herein are techniques related to control of a system. According to some embodiments the system includes a plurality of elements and a power supply to supply power to the elements. According to some embodiments the method comprises: delivering a clock signal to a subset of elements, the clock signal defining a sequence of clock pulses; determining, for a first clock pulse, elements in the subset to consume power; and controlling the power supply. A system is disclosed having a plurality of elements including a subset of elements, a power supply to supply power to the elements, a clock signal delivery configured to deliver a clock signal to the subset of elements in the plurality of elements, and a control module configured to control the power supply based on the determining elements to consume power. An apparatus and a device for use in a system are also disclosed.

### BACKGROUND

Dynamic voltage scaling is a power management technique in computer architecture, where the voltage used in a component is increased or decreased, depending upon circumstances. Dynamic frequency scaling is a technique in computer architecture whereby the frequency of a microprocessor can be automatically adjusted “on the fly,” either to conserve power or to reduce the amount of heat generated by the chip. Voltage and frequency scaling are often used together to save power in mobile devices including cell phones. When used in this way it is commonly known as DVFS, or Dynamic Voltage and Frequency Scaling.

### SUMMARY

The following presents a simplified summary in order to provide a basic understanding of one or more aspects of techniques disclosed herein. This summary is not an extensive overview, and it is neither intended to identify key or critical elements, nor to delineate the scope of this disclosure. Rather, the primary purpose of the summary is to present some concepts in a simplified form as a prelude to the more detailed description that is presented later.

This disclosure is directed to techniques for reducing power consumption. In particular, in a low power mode, a clock frequency may be reduced so that clock cycles become large. Techniques disclosed herein make use of time available in a relatively large clock cycle to obtain information for use in power supply control. At least one effect can be to adjust power supply clock pulse by clock pulse to cover a need for power associated with the respective clock pulse.

In a digital circuit, capacitances can, for example, be provided as buffers configured to block current spikes that can occur when switching the circuit's elements, in particular when switching storage elements such as, for example, flip-flops. Hereinafter, the term ‘flip-flop’ is used representatively for storage elements. It should be understood that the techniques disclosed herein are not limited to flip-flops, but also encompass other circuit elements configured to receive an activation signal to start an operation of the circuit element. Other circuit elements, for example, are latches, random access memory (RAM) and read only memory (ROM). Further, it should be understood that an enable signal for receipt at a latch or an asynchronous write signal for receipt at a RAM, an asynchronous read signal for receipt at a RAM or at a ROM can also form activation signals. Clock gates can be used to disable delivery of a clock signal to a circuit domain including flip-flops that are known not to be switched. As a result, flow of charges to capacitances of the circuit domain can be reduced. The techniques described herein can use information related to clock signal delivery to the circuit domain in control of a power supply configured to supply power to the domain.

In order to safely store information in a flip-flop, voltage supplied to the flip-flop should not drop below a level predetermined by design. In particular, voltage across a buffer capacitance associated with the flip-flop should not drop below the predetermined level. In order to keep the voltage from falling below the predetermined level during discharge of the buffer capacitance, sufficient charge must be stored in the buffer capacitance in the first place. The techniques disclosed herein are based on anticipating a loss, associated with an occurrence of a clock pulse, of charge from a given set of buffer capacitances associated with flip-flops to be switched. Based on the anticipated loss, a voltage required to precharge the given set of capacitances can be determined. In particular, an amount of flip-flops to be switched can be anticipated so as to anticipate a precharge voltage to compensate loss of charge from the associated buffer capacitances. Thus, supply power can be scaled depending an amount of clock gates that receive a clock signal and deliver the same to a predetermined number of flip-flops or that receive an enable signal for flip-flops to be operative. In some implementations the scaling can be performed as frequently as clock cycle by clock cycle or clock pulse by clock pulse. At least one effect can be to use less power, since power consumption can be controlled more closely according to the power needed.

This summary is submitted with the understanding that it will not be used to interpret or limit the scope or meaning of the claims. Those skilled in the art will recognise additional features and advantages upon reading the following detailed description, and upon viewing the accompanying drawings.

### BRIEF DESCRIPTION OF THE DRAWINGS

The claimed subject matter is described below with reference to the drawings. For purposes of explanation, numerous specific details are set forth in order to provide a thorough understanding of the claimed subject matter. It may be evident, however, that the claimed subject matter may be practised without these specific details. The detailed description references the accompanying figures. The same numbers are used throughout the drawings to reference like features and components. Where multiple embodiments are described, multi-digit reference numerals are used to denote elements in the embodiments. In multi-digit reference numerals the least significant digits can reference features and components that are alike in the different embodiments, whereas the most significant digit can reference the specific embodiment.

FIG. 1 is an exemplary block diagram of a system according to some embodiments.

FIG. 2 is an exemplary block diagram that illustrates schematically the system of FIG. 1 in another aspect in accordance with some embodiments.

FIG. 3 is another exemplary block diagram that illustrates schematically the system of FIG. 1 in yet another aspect in accordance with some embodiments.

FIG. 4 is another exemplary block diagram that illustrates schematically the system of FIG. 1 in yet another aspect in accordance with some embodiments.

FIGS. 5A and 5B are exemplary diagrams that schematically illustrate a portion of the system in FIG. 1 in accordance with some embodiments.

FIG. 6 is a flow chart illustrating an implementation of techniques according to some embodiments.

FIGS. 7A, 7B and 7C are an exemplary timing diagrams that schematically illustrate clocking, flip-flop count and power consumption in an implementation according to the techniques disclosed herein.

### DETAILED DESCRIPTION

Described herein are embodiments that relate to processing signals and/or data in a system according to techniques disclosed herein. For purposes of explanation, numerous specific details are set forth in order to provide a thorough understanding of the claimed subject matter. It may be evident, however, that the claimed subject matter may be practised without these specific details.

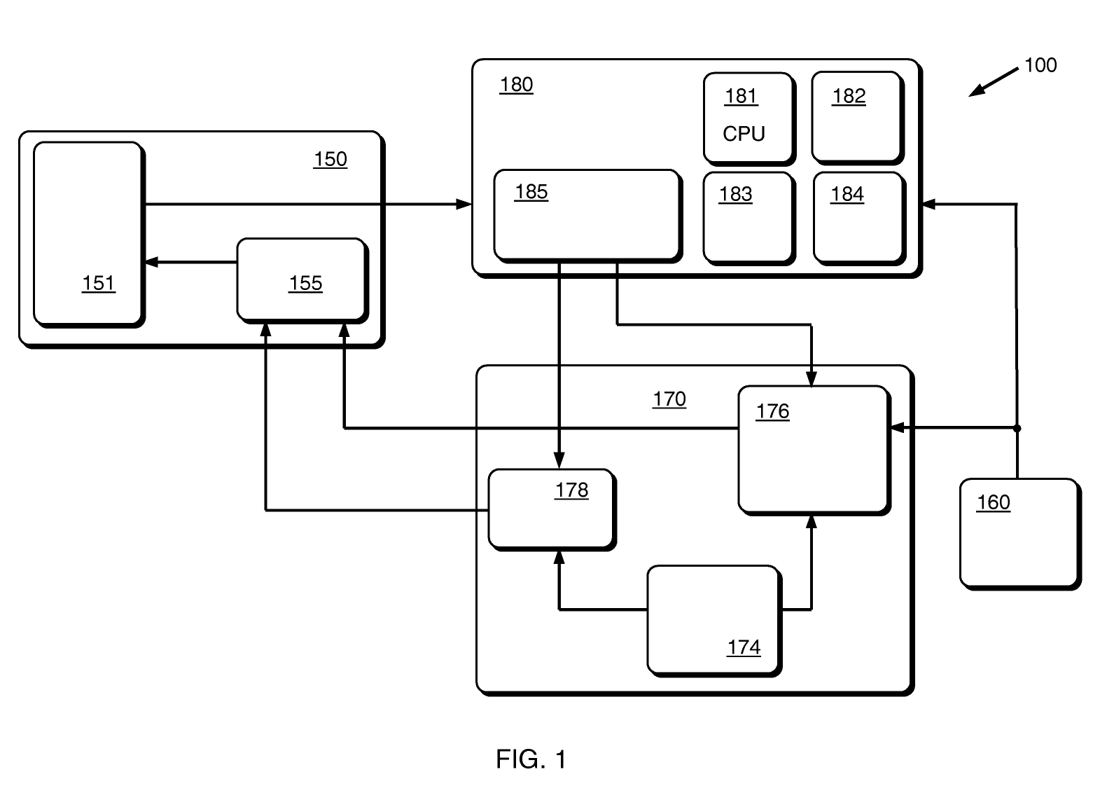

FIG. 1 is a block diagram that illustrates schematically functional aspects of a system 100 in accordance with some embodiments. System 100 includes a processing unit 180. Further, system 100 includes a power supply unit 150 configured to supply power to circuitry included in or otherwise represented by processing unit 180 of system 100. According to some embodiments system 100 includes an analyser unit 170 configured to receive signals from processing unit 180 and further configured to provide signals to power supply unit 150. System 100 also includes a clock generation unit 160 configured to deliver clock pulses to processing unit 180. In some embodiments clock generation unit 160 can be configured to deliver clock pulses to the analyser unit 170. According to some embodiments system 100 can include and/or be coupled to a system memory configured to store programme instructions and or data for use in data processing by system 100. In some implementations system 100 comprises other peripheral circuitry (not shown in FIG. 1).

Processing unit 180 can comprise one or more of, for example, a central processing unit (CPU) 181, one or more memory units 182, herein also referred to as system memory, one or more peripheral units such as, for instance, timer 183 and communication interface 184 configured for communication of system 100 with devices external to system 100. Timer 183, in some embodiments, is configured to generate a pulse width modulated (PWM) signal. The PWM signal can, for example, be provided to power supply unit 150 for control of power supply functions. In some embodiments the PWM signal can be used to trigger interrupts. In some implementations the PWM signal can form a reference signal for use in operating system 100. Communication interface 184, in some embodiments, can be configured for use in communication with other device. In some implementations communication interface 184 is configured to enable communication according to at least one protocol in a group of protocols comprising: Local Interconnect Network (LIN), Serial Peripheral Interface (SPI) and Controller Area Network (CAN). The person skilled in the art will understand that the list of elements comprised in processing unit 180 is merely to state examples that either alone or in any combination including multiple implementations of units and/or functional blocks can be implemented together in the processing unit. As processing needs demand, and as the case may be, processing unit 180 can include other processing circuitry. Further, processing unit 180 includes a clock gating interface 185 configured for coupling processing unit 180 to analyser unit 170. It should also be understood that not all circuitry of processing unit 180 needs to be collocated. In some embodiments circuitry represented by processing unit 180 is distributed, for example, across a plurality of processing cores of an integrated circuit chip, or even across a plurality of integrated circuit chip.

Analyser unit 170 includes an analyser memory 174 that in some implementations is configured to hold data representative of information related to configuration of system 100 and/or setting of system 100 for operation and/or related to operating system 100. Other data that represents other information can also be stored in analyser memory 174. In some embodiments the information includes flip-flop counts. The wording ‘flip-flop count’, herein also referred to as ‘gate count’, encompasses any circuit element that is configured to receive an activation or other enable/disable signal to perform an operation. Thus, flip-flop counts can be a number that states the number of flip-flops, for example, present in a clock branch or, for example, the number of flip-flops to be clocked during execution of a given operation. In some implementations this information, for storage in analyser memory 174, can have been extracted from design information related to design of system 100. In some implementations the information is stored in a programmable portion of analyser memory 174, e.g., the information can be written into a random access memory (RAM) of analyser memory 174. In some embodiments the information is hard-coded into analyser memory 174, i.e., defined by design of system 100 and stored in a read-only memory (ROM) portion of analyser memory 174.

In some embodiments analyser unit 170 includes an instruction analyser 176 coupled to analyser programme memory 174. Instruction analyser 176 is configured to analyse instructions provided for execution by CPU 181. In an implementation instruction analyser 176 is configured to provide instruction analysis information related to flip-flops to be clocked during execution of a given instruction. In an embodiment instruction analyser 176 is configured to output instruction analysis information that includes the number of flip-flops in processing unit 180 to be clocked during execution of the given instruction in a subsequent clock cycle such as, in some embodiments, the next clock cycle. Further, instruction analyser 176 is forward-coupled to power supply unit 150 and configured to provide instruction analysis information to power supply unit 150.

In some embodiments analyser unit 170 includes a peripheral analyser 178 coupled to analyzer memory 174. Peripheral analyser 178 is configured to analyse actions and operations related to peripheral circuitry such as controlling timer 183 and operating communication interface 184. In an implementation peripheral analyser 178 is configured to provide peripheral analysis information related to clock branches 110, 120, 130 to be clocked depending, for example, on operating in a predetermined mode of operation peripheral unit such as timer 183 and/or communication interface 184. In an embodiment peripheral analyser 178 is configured to output peripheral analysis information that includes the number of flip-flops in clock branches 110, 120, 130 to be clocked in a subsequent clock cycle such as, in some embodiments, in the next clock cycle. Further, peripheral analyser 178 is forward-coupled to power supply unit 150 and configured to provide information related to operation of peripheral circuitry to power supply unit 150.

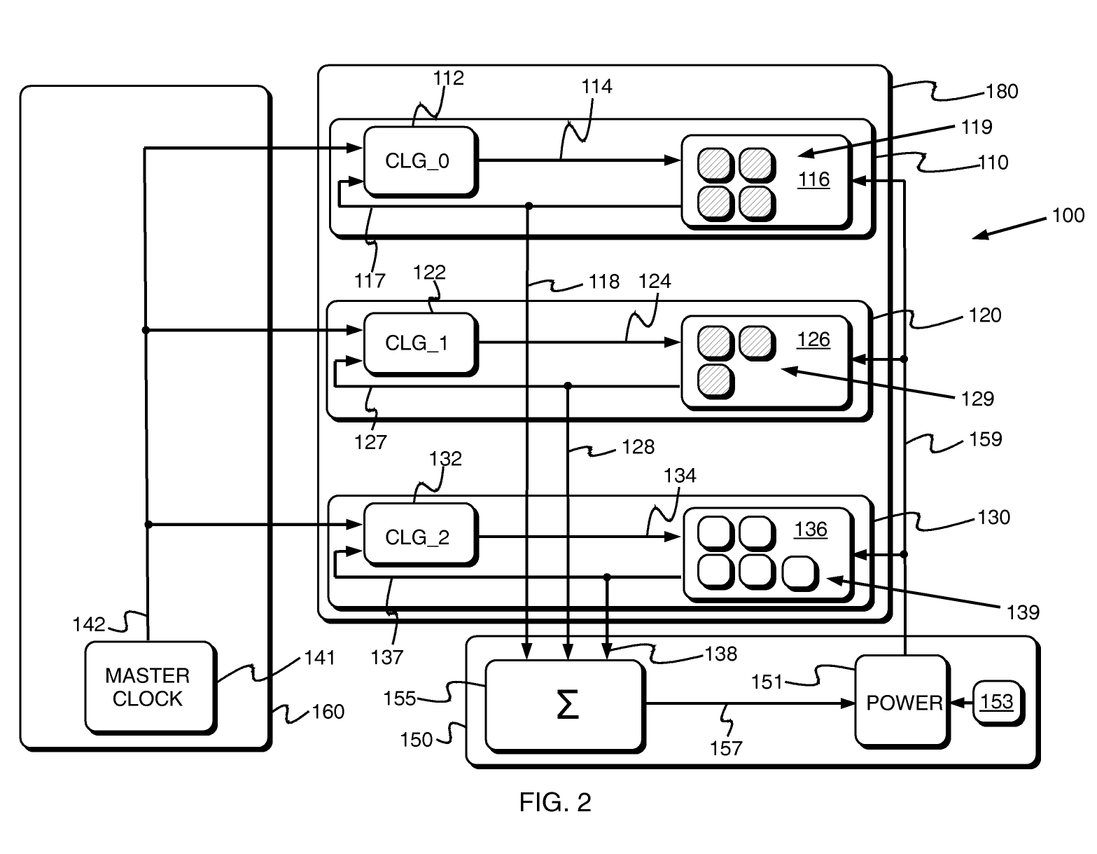

FIG. 2 is an exemplary block diagram that illustrates schematically structural aspects of the system of FIG. 1 in accordance with some embodiments. As shown in FIG. 2, system 100 can include circuitry that comprises clock generation unit 160 and a clock tree. The clock tree can, as the case may be, be coupled to clock generation unit 160, or in some implementations at least a portion of the clock tree can form part of clock generation unit 160. The clock tree can, for example, extend into processing unit 180. The clock tree includes clock branches such as, for example, a first clock branch 110, a second clock branch 120 and a third clock branch 130. For example, first clock branch 110 can form part of central processing unit 181. For another example, second clock branch 120 can form part of memory unit 182. For yet another example, third clock branch 130 can form part of one of the peripheral units such as timer 183 or communication interface 184. The number of branches, three in the example shown in FIG. 2, must not be understood as limiting since the clock tree could comprise any different number of branches as will be understood when discussing aspects of system 100 in more detail below. Power supply unit 150 is configured to supply power, so as to operate the circuitry in clock branches 110, 120, 130, to first clock branch 110, and to second and third clock branches 120, 130.

As one example of a clock branch, first clock branch 110 includes a first clock gate 112 that is configured to deliver a first clock signal to a first flip-flop set circuit portion 116 that comprises a first set 119 of flip-flops of the circuitry in system 100. First clock gate 112 thus defines the first clock branch 110. A first coupling circuitry 114, connected to first clock gate 112 as well as to flip-flops in first flip-flop set circuit portion 116, can be configured to enable delivery of the first clock signal from first clock gate 112 to all flip-flops comprised in first flip-flop set circuit portion 116. For being configured to receive the first clock signal, all flip-flops comprised in first flip-flop set circuit portion 116 are said to be allocated downstream of first clock gate 112. An activity signal that represents information related to first flip-flop set circuit portion 116 can be transmitted from first flip-flop set circuit portion 116 to first clock gate 112 via first feedback circuitry 117. In some embodiments, first feedback circuitry 117 is provided by signal line. First clock gate 112, in some embodiments, can be provided as a logic gate configured to receive, at a first logic input port, the first clock signal from clocking portion 140 and, at a second logic input port, the activity signal from first flip-flop set circuit portion 116.

First clock branch 110 can further be coupled to power supply portion 150. For example, first clock branch 110 can include a first signal line 118 connected between first coupling circuitry 117 and power supply portion 150, wherein first signal line 118 can be configured to provide the activity signal from first clock branch 110 to power supply portion 150.

The afore-described embodiments of first clock branch 110, can be also be implemented, as shown in FIG. 2, in second clock branch 120 having, in a second flip-flop set circuit portion 126, a second set 129 of flip-flops and in third clock branch 130 having, in a third flip-flop set circuit portion 136, a third set of flip-flops 139. It should be understood that clock branches can be implemented differently. For example, logic functionality implemented in logic gates 112, 122, 132 can differ from one clock branch to another. Also, the number of flip-flops in flip-flop set circuit portion 116, 126, 136 can differ from one clock branch to another.

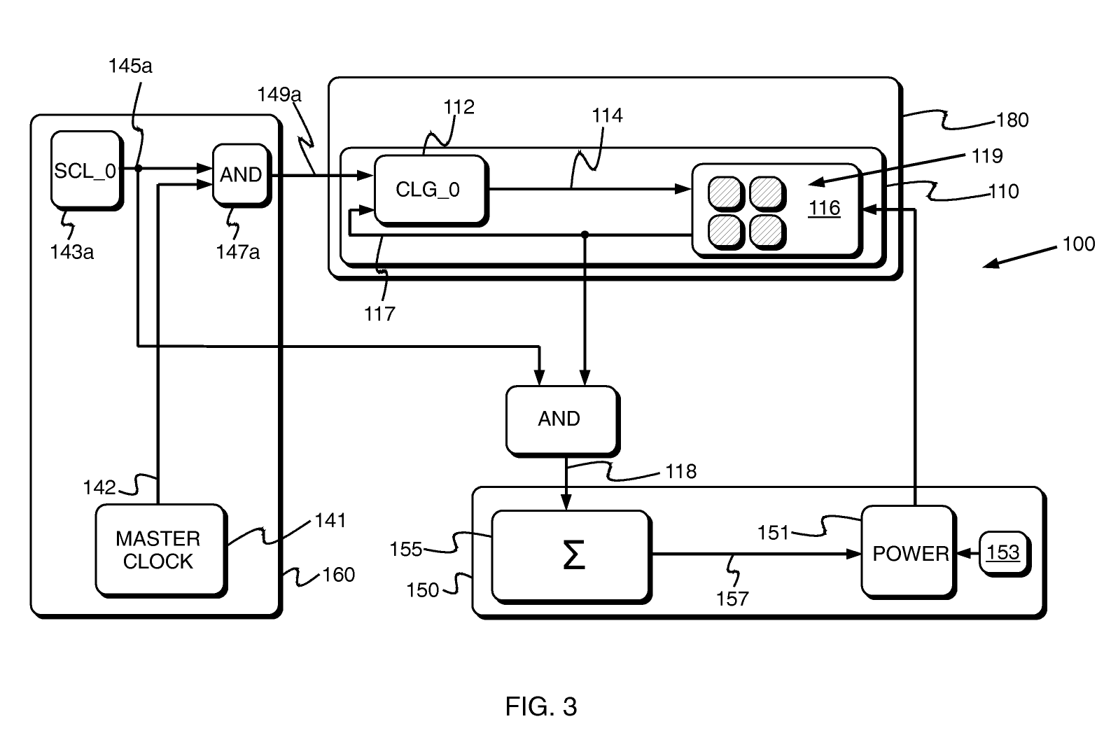

FIG. 3 is an exemplary block diagram that illustrates schematically further structural aspects of the system of FIG. 1 in accordance with some embodiments. As shown in FIG. 3 clocking portion 160 includes a master clock 141 and a master clock signal line 142 configured to be used as the master clock tree. Clocking portion 140 can further include clock circuitry configured to enable delivery of clock signals to the clock tree of system 100, in particular, in the example shown in FIG. 2, to first clock branch 110, to second clock branch 120 and to third clock branch 130, and, as the case may be, to other clock branches (not shown). Referring back to FIG. 3, the clock circuitry can comprise a clock signal control portion 143, that can be coupled to first clock branch 110. In some implementations, clock signal control portion 143 can be connected via a clock signal control line 145, to an associated clock logic gate 147. Thus, clock signal control portion 143 can be configured to provide a clock divider signal to associated clock logic gate 147. In some embodiments associated clock logic gate 147 can be provided as an AND gate having a first signal input coupled to master clock line 142 to receive the master clock signal from master clock 141. It should be understood that the embodiments described above with reference to first clock branch 110 can also be implemented for one or more of second clock branch 120, third clock branch 130 and other clock branches (not shown), if any. At least one effect of the structure according to the above-described embodiments is to enable delivery of clock signals to clock branches 110, 120, 130 independent from one another, e.g., to enable operation of first clock branch 110 with another frequency than a frequency used for operation of second clock branch 120, and with yet another frequency used in operation of third clock branch 130.

Further, associated clock logic gates 147 can have a second signal input configured to receive the clock divider signal from clock signal control portion 143. Clock logic gate 147 can have a clock signal output to connect clocking portion 140, via an associated clock line 149a, 149b, 149c, herein also collectively referenced by numeral 149, to the first clock branch 110, to the second clock branch and to the third clock branch 130, respectively. Thus, as an example, the master clock signal can be divided according to the clock divider signals received from the associated clock signal control portions 143, respectively, to generate branch clock signals for delivery to first clock branch 110, second clock branch 120 and to third clock branch 130, respectively.

Power supply portion 150 includes a power supply circuit 151, a settings unit 153 coupled to power supply 151 and configured to enable setting of power supply 151 and an aggregator unit 155 that is coupled to power supply 151, for example as shown in FIG. 1, by line 157. In some embodiments aggregator unit 155 is configured to receive branch signals provided to power supply portion 150 via first branch signal line 118, second branch signal line 128 and third branch signal line 138. Aggregator unit 155 is configured to use the branch signals in generating an aggregate signal for output to power supply 151 as will be described in more detail below.

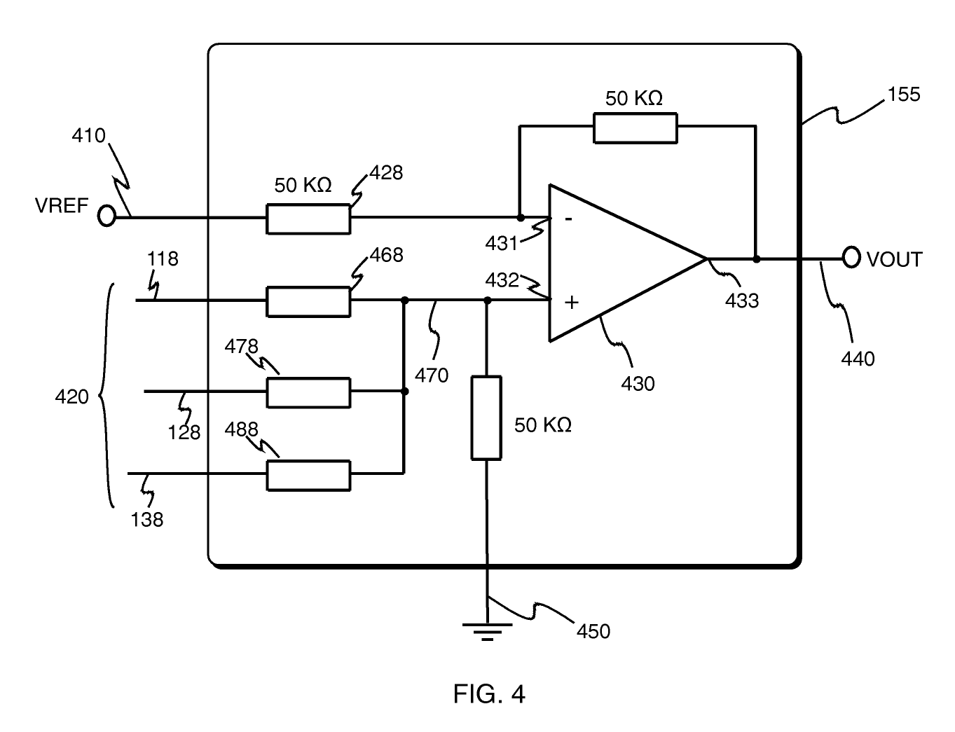

FIG. 4 is an exemplary block diagram that schematically illustrates aggregator unit 155 according to some embodiments. Aggregator unit 155 includes a reference input terminal 410, a set 420 of signal input terminals, an operational amplifier 430 having a first port 431, coupled to reference input terminal 410 via a reference resistance 428, and a second port 432 coupled, via an aggregated input line 470 to set 420 of signal input terminals, and an output terminal 440 coupled to an output port 433 of operational amplifier 430. Aggregator unit 155 further comprises a coupling 450 of second port 432 to ground.

In some implementations, as shown for example in FIG. 4, first, second and third signal lines 118, 128 and 138 are configured to provide feedback signals from first, second and third flip-flop set circuit portion 116, 126 and 136, respectively, to set 420 of signal input terminals. According to some embodiments, aggregator unit 155 includes a first weighting resistance 468 coupled between first signal line 118 and aggregated input line 470. Likewise, in some implementations aggregator unit 155 further includes a second weighting resistance 478 coupled between second signal line 128 and aggregated input line 470 and, in some embodiments, aggregator unit 155 includes a third weighting resistance 488 coupled between third signal line 138 and aggregated input line 470. In some implementations, some or all of first, second and third weighting resistances 468, 478 and 488 are selected to reflect a number of flip-flops in first, second and third clock branch 110, 120 and 130, respectively.

In some embodiments, aggregator 155 is configured to provide a signal via aggregated input line 470 to second input port 432 of operational amplifier 430 whose strength is commensurate or otherwise corresponds to the number of flip-flops clocked. Using the example shown in FIG. 2, an implementation of weighting can be provided as follows: First weighting resistance 468 associated with first clock branch 110 can be 1000 Ohm commensurate with four equally sized blocks of flip-flops in first flip-flop set circuit portion 116. Second weighting resistance 478 associated with second clock branch 120 can be 1250 Ohm commensurate with three equally sized blocks of flip-flops in second flip-flop set circuit portion 126. Third weighting resistance 488 associated with third clock branch 130 can be 750 Ohm commensurate with five equally sized blocks of flip-flops in third flip-flop set circuit portion 136.

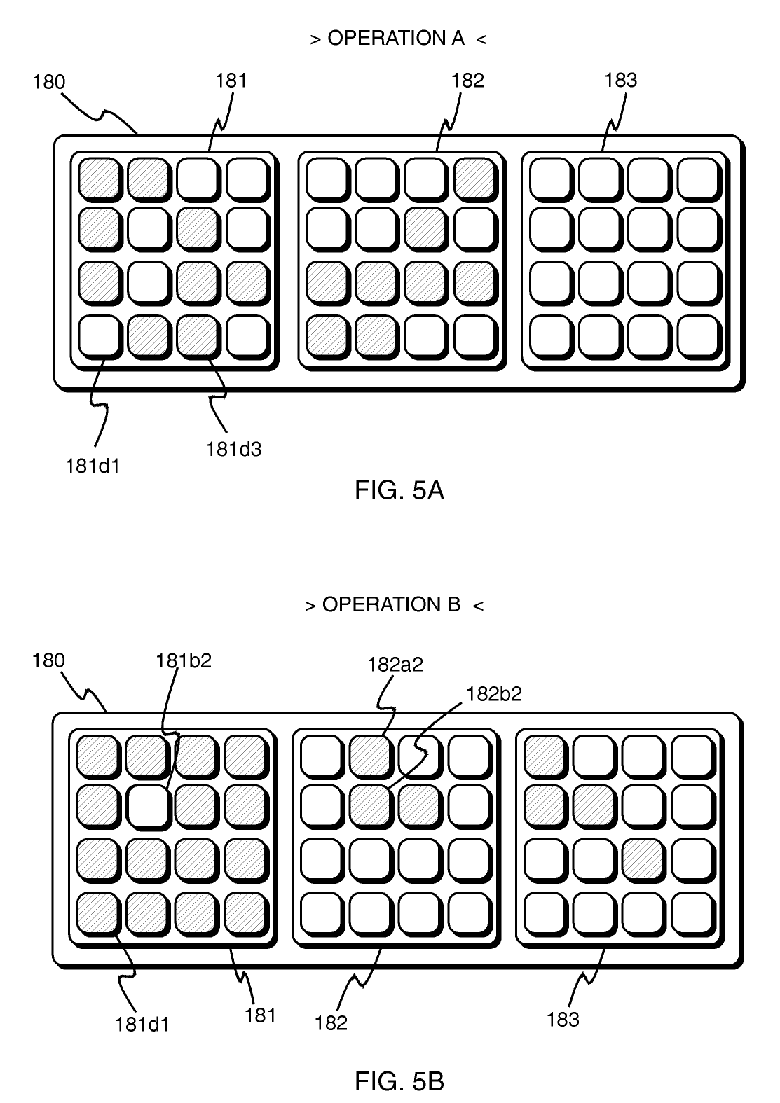

Now, with reference to FIGS. 5A and 5B, processing unit 180 according to some exemplary embodiments is described in more detail. Processing unit 180 can comprise a plurality of functional blocks each configured to provide a certain processing functionality. In the example shown in FIGS. 5A and 5B, processing unit 180 includes at least a first functional block corresponding to CPU 181, a second functional block corresponding to memory unit 182 and a third functional block corresponding to timer 183. It should be understood that FIGS. 5A and 5B both illustrate the same functional blocks 181, 182, 183. Further it should be understood that the number of functional blocks included in processing unit 180 as shown herein is for exemplary purposes only and can differ in accordance with functional needs in a given implementation.

In the exemplary embodiment each functional block 181, 182, 183 includes sixteen blocks of flip-flops such as, in the case of first functional block 181, blocks of flip-flops 181a1, 181a2, . . . . , 181d4. In FIGS. 5A and 5B, for intelligibility of the drawings, reference numerals are shown only for a few selected blocks of flip-flops. A block of flip-flops contains a predetermined number of flip-flops. In typical embodiments the number of flip-flops in a given block of flip-flops depends on one or more tasks to be performed by the block of flip-flops. In particular, the one or more tasks can be determined within processing unit functionality. It should be understood that the number of blocks of flip-flops included in each functional block 181, 182, 183 as shown herein is for exemplary purposes only and, as the case may be according to implementation, can differ from one functional block 181 to another functional block 182. In some embodiments each block of flip-flops is associated with a different clock gate that is configured to deliver clocking to the associated block of flip-flops. In some embodiments at least some blocks of flip-flops are, together, associated with one common clock gate that is configured to deliver clocking to the associated blocks of flip-flops. In some implementations at least two clock gates are arranged sequentially wherein one clock gate delivers clocking to the other. In some implementations multiple clock gates can be configured to receive clocking from the one clock gate so as to form a hierarchical arrangement of clock gates wherein, for example, the one clock gate defines a clock branch, and the multiple clock gates configured to receive clocking form the one clock gate each define a clock sub-branch.

In FIGS. 5A and 5B, to illustrate clocking delivered to blocks of flip-flops, blocks of flip-flops shown in clear white receive clocking while blocks of flip-flops shown with hatching do not receive clocking. For example, in FIG. 5A block of flip-flops 181d1 receives clocking, while block of flip-flops 181d3 does not receive any clocking. FIG. 5A shows a first exemplary clocking state of functional blocks 181, 182 and 183 when executing a first operation A and FIG. 5B shows a second exemplary clocking state of functional blocks 181, 182 and 183 when executing a second operation B. It should be understood that in some embodiments each functional block comprised in processing unit can be associated with a separate clock gate (not shown) that is configured to deliver clocking to all blocks of flip-flops of the respective functional block 181, 182, 183.

During execution of the first operation A, as shown in FIG. 5A, in first functional block 181 nine blocks of flip-flops, for example block of flip-flops 181d1, receive clocking while seven other blocks of flip-flops such as block of flip-flops 181d3 do not receive any clocking. Second functional block 182 includes eight blocks of flip-flops that receive clocking as well as eight blocks of flip-flops that do not receive any clocking. In functional block 183 all blocks of flip-flops receive clocking. In another implementation (not shown), none of the blocks of flip-flops in second functional block 183 receives any clocking and the associated second clock signal branch 130 can be severed from clocking delivered from clock generation unit 160 by delivering a corresponding feedback signal via line 137 to second clock signal gate 132 so as to block second clock gate 132 to clocking signals.

During execution of the second instruction B, as shown in FIG. 5B, in first functional block 181 only one block of flip-flops 181b2 receives clocking while fifteen other blocks of flip-flops do not receive any clocking. Similarly, second functional block 182 now includes three blocks of flip-flops 182a2, 182b2 and 182b3 that do not receive any clocking while thirteen other blocks of flip-flops in second functional block 182 receive clocking. Finally, third functional block 183 now includes twelve blocks of flip-flops that receive clocking while four other blocks of flip-flops in third functional block 183 do not receive any clocking. Thus, from execution of one instruction (first instruction A) to the next (second instruction B),

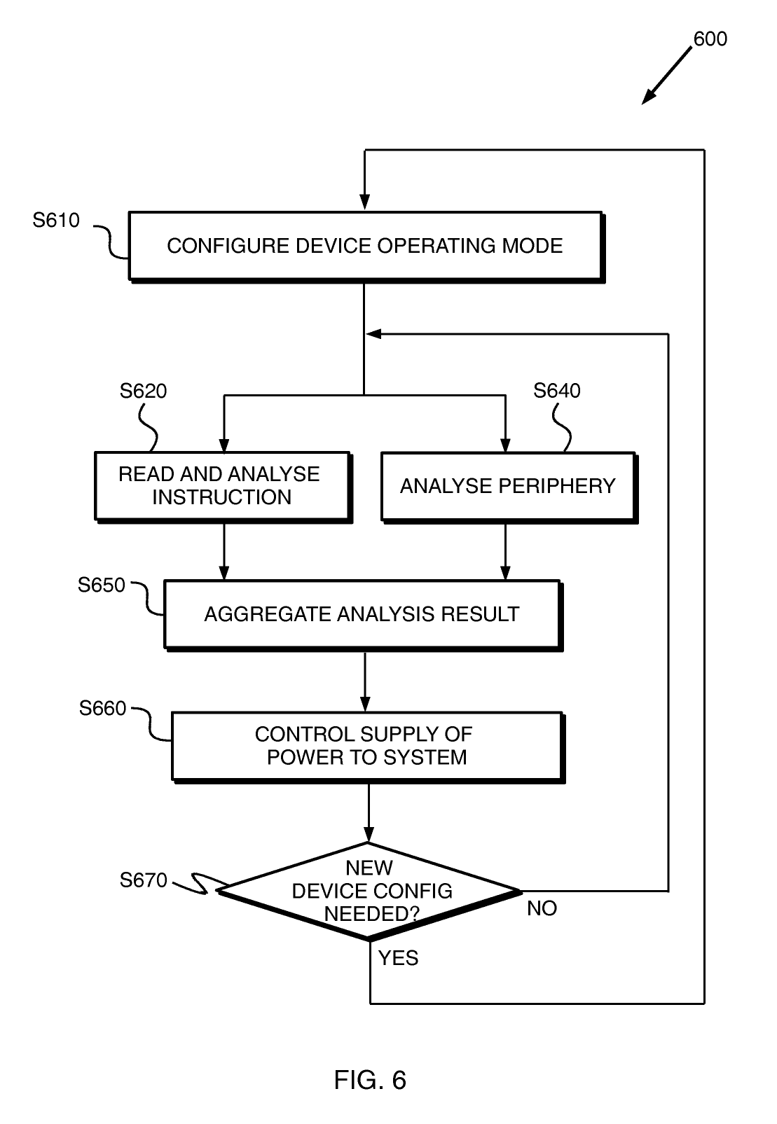

FIG. 6 is a flow chart illustrating an implementation of techniques according to some embodiments. In an embodiment a method 600 comprises, at S610, configuring system 100. In some embodiments configuring includes loading configuration data to analyser memory 174.

In some embodiments configuration data comprises and/or represents or otherwise relates to information on a number of flip-flops that receive clocking, herein also referred to as ‘clocked flip-flops’, when performing a given operation. In one example, not meant to limit in any way the disclosure herein, an implementation may comprise instruction code stored in analyser memory 174 that, when executed, is known to require flip-flops to receive clocking, for one example, in the case of CPU 181 executing instructions as analysed in process analyser 176, as stated in TABLE 1 below:

TABLE 1

| INSTRUCTION | COUNT OF CLOCKED FLIP-FLOPS |
|---|---|
| AND | 16 |
| MOV | 16 |
| LOAD | 40 |

Accordingly, configuration data, in the given example, can include the information as stated in TABLE 1, i.e., an instruction and a flip-flop count associated with execution of the instruction, wherein the flip-flop count states the number of flip-flops in processing unit 180 that are clocked when the associated instruction is executed. It should be understood that the instructions and numbers stated in the exemplary table associating selected instructions with flip-flop count are selected and stated arbitrarily, merely to illustrate the example, and in a given implementation the table can include other instructions and other associated flip-flop counts. In another example, peripheral operations to be analysed by peripheral analyser 178 can encompass an operation to increment a value stored in timer 183, another operation to receive data via communication interface 184, and yet another operation to perform an analog-to-digital conversion.

In some embodiments configuration data further comprises and/or represents or otherwise relates to information on a number of flip-flops that receive clocking in flip-flop set circuit portion 116, 126, 136 of a given clock branch 110, 120, 130, respectively. In one example, not meant to limit in any way the disclosure herein, an implementation is known, when performing a selected operation D, to require clocking of flip-flops as stated in TABLE 2 below:

TABLE 2

| CLOCK GATE | COUNT OF CLOCKED FLIP-FLOPS |
|---|---|
| CLG_0 | 300 |
| CLG_1 | 150 |
| CLG_2 | 680 |

Accordingly, configuration data, in the given example, can include the information in a table as stated above, i.e., a clock gate 112, 122, 132 and a flip-flop count associated with the clock branch 110, 120, 130 defined by the clock gate, wherein the flip-flop count states the number of flip-flops in clock branch 110, 120, 130 that receive clocking when the associated clock gate 112, 122, 132 delivers a clock signal. It should be understood that the clock gates and numbers stated in the exemplary tables associating selected clock gates with flip-flop count are selected and stated arbitrarily, merely to illustrate the example, and in a given implementation the table can include other instructions, clock gates and other associated flip-flop counts.

After a device operating mode has been selected that implements and uses the techniques described herein to control power in system 100 so as to scale voltage and, in effect, have system 100 consume little power. In some device operating modes voltage scaling can be disabled. In some device operating modes voltage scaling can be enabled. In some implementations disabling/enabling of voltage scaling can be determined or otherwise depend on activity of the blocks of flip-flops in operation of system 100.

At S620, a processing instruction is read from system memory for execution by the CPU 181 in processing unit 180 with a later clock pulse, in some embodiments with the next clock pulse, and for analysis into analyser unit 170.

Instruction analyser 176 analyses the processing instruction read from system memory to identify an associated information on a number of flip-flops that switch state when executing the processing instruction read from system memory. For example, if the instruction MOV is to be executed next, instruction analyser 176, in accordance with the information stated in TABLE 1, identifies the instruction MOV to be associated with a flip-flop count of 16.

At S640, in some implementations at the same time as step S620, peripheral analyser 178 of analyser unit 170 analyses peripheral activity. In some implementations a plurality of operations and more can be associated with a sequence of operations performed when operating system 100. The sequence can be defined, for example, by design or by construction of peripheral units. In some embodiments at least portions of the sequence of operations to be performed when operating system 100 can be configurable. For example, in some embodiments a sequence of operations A, B, C and D is predetermined. Thus, a current state of processing, e.g., one peripheral unit such as timer 183 performing operation A, can be associated with another state of processing that is subsequent to the current state of processing, e.g., another peripheral unit such as communication interface 184 performing operation B after operation A is completed. Accordingly, in some embodiments peripheral analyser 178 identifies clock gates 112, 122, 132 that, during future clock cycles will deliver a clock signal to all flip-flops comprised in the associated flip-flop set of circuit portion 110, 120, 130. In some embodiments peripheral analyser 178 in particular identifies clock gates 112, 122, 132 that will deliver a clock signal to all flip-flops comprised in the associated flip-flop set of circuit portion 110, 120, 130 during the next clock cycle. Further, peripheral analyser 178 identifies, for each identified clock gate 112, 122, 132, a flip-flop count that states the number of flip-flops that are included in the flip-flop set of circuit portion 116, 126, 136 of the clock branch 110, 120, 130 associated with the identified clock gate 112, 122, 132. For example, if first clock gate 112 is identified to deliver a clock pulse to the flip-flops comprised in the first flip-flop set circuit portion 116 of first clock branch 110 during the next clock cycle, peripheral analyser 178, in accordance with the information stated in TABLE 2, identifies first clock gate 112 to be associated with a flip-flop count of 30.

At S650 power supply portion 150 receives analysed flip-flop counts from analyser unit 170 and aggregator unit 155 aggregates the received flip-flop counts. In an embodiment aggregating flip-flop counts includes forming a sum of flip-flop counts. In one embodiment forming a sum of flip-flop counts is adding all flip-flop counts that are received with respect to the next clock cycle. At least one effect can be that an estimate of power consumption to occur in connection with the next clock pulse delivered from clocking unit 140 to other portions of system 100 can be based on aggregated flip-flop counts, in particular, on the sum of all flip-flop counts. It should be understood that the wording ‘flip-flop count’ as used herein represents a number of circuit elements or gates that are activatable by an activation signal. Likewise, the wording ‘clock signal’ and ‘clocking’ as used herein represents an activation signal to activate/deactivate the activatable element. In some embodiments aggregating flip-flop counts can further include providing a control value for use in control of power supplied to system 100. In some embodiments the providing can include looking up a control value associated with a given aggregate flip-flop count in a lookup table such as stated in exemplary TABLE 3 below:

TABLE 3

| FLIP-FLOP COUNT | VOLTAGE (mV) |
|---|---|
| 100 | 2000 |
| 2000 | 2700 |
| 1100 | 2600 |
| 1000 | 2550 |

At S660 aggregator unit 155 outputs a control signal to line 157 for setting power supply 151 to the control value associated with the aggregate flip-flop count. In an embodiment the control value is a voltage value commensurate with switching all flip-flops identified to switch when executing the next processing instruction in processing unit 180 and/or in peripheral circuitry in clock branches 110, 120, 130 to which clock gates 112, 122, 132 deliver clocking signals during the next clock cycle.

Having completed steps S620 to S6260 of the power saving routine as described above, as the case may be, S620 to S660 can be repeated to set power supply 151 according to a control value commensurate with flip-flops to be switched and/or clocked during another next clock cycle, or, at an end of processing or for another reason such as an end of a low power mode, at S670 the above described power saving routine can be exited.

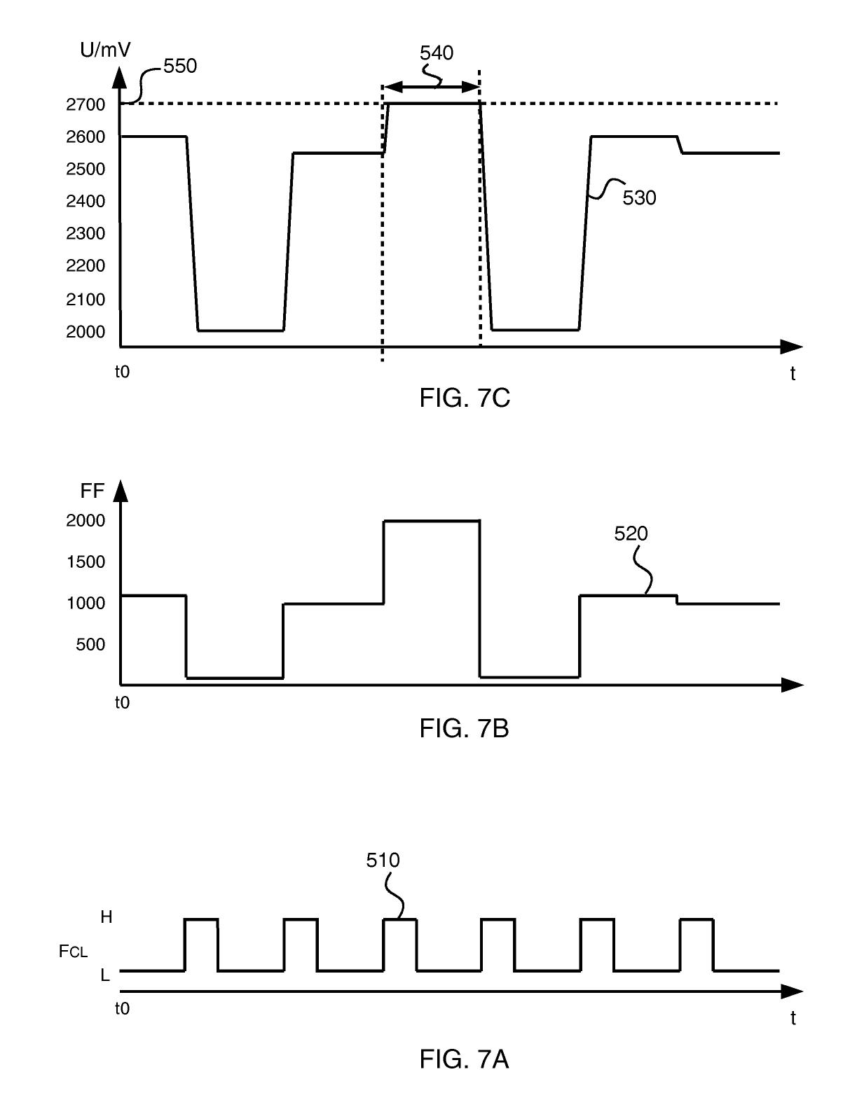

FIGS. 7A, 7B and 7C are exemplary timing diagrams that schematically illustrate clocking (FIG. 7A), flip-flop count (FIG. 7B) and power savings (FIG. 7C) that can be achieved in an implementation of the techniques disclosed herein.

FIG. 7A illustrates a clocking signal 510 according to an exemplary embodiment. In some embodiments clocking signal 510 is delivered from master clock 141 via a master clock signal line 142 to the clock tree. It should be understood that clock signal 510 is shown as an example and parameters such as signal shape and duty cycle are without any intention to limit the disclosure to the shown example.

FIG. 7B illustrates an exemplary flip-flop count time line 520 corresponding to clock signal 510 for some exemplary embodiment of system 100 having flip-flop counts as stated in TABLE 3 above, wherein the flip-flops are scheduled to be clocked in a subsequent clock cycle. In one embodiment, for example, gate counts relate to gates that are determined to receive clocking in the next clock cycle.

FIG. 7C illustrates an exemplary voltage curve 530 corresponding to clock signal 510 for the exemplary embodiment of system 100 in FIG. 7B that has flip-flop counts as stated in TABLE 3 above. Voltage supplied from power supply unit 150 to other portions of system 100, and thus power consumption of system 100, varies with time. A maximum voltage is supplied in time interval 540 where the sum of number of flip-flops that receive clocking and number of flip-flops that are switched is largest as can be seen in FIG. B. Whereas a conventional system, in order to avoid at any time that charge stored on precharge capacitances drops below a level where flip-flop operation is not reliable, would require a supply voltage at a level 550 of the maximum voltage throughout operation, in system 100 according to the embodiments disclosed above or when otherwise implementing the techniques described above, supply voltage can be adjusted below level 550 of the maximum voltage commensurate with the number of flip-flops to be switched or other gates to be activated during an upcoming clock cycle or other next operation. Thus, at times shown other than time interval 540, power is saved.

In the above-described exemplary embodiments flip-flop count is analysed both with respect to flip-flop switching in the processing unit associated with given instructions and delivering clocking to clock tree branches associated with given instructions. However, the person skilled in the art will understand that an implementation of the techniques described herein can also be limited to analysing instructions to identify which clock gates will deliver clock signals but not analysing instructions to identify which flip-flops in the processing unit will be switched, or vice versa. The skilled person would nevertheless arrive at an estimate basis for adapting supply power for the system at a sufficiently high level for pre-charging capacitances to safely operate flip-flops of the system while still benefiting from advantageous power saving effects of the techniques described herein.

This description, in an aspect according to some embodiments, describes a method for use in control of a system, the system to include a plurality of elements and a power supply to supply power to the plurality of elements. An embodiment comprises delivering a clock signal to a subset of elements in the plurality of elements, the clock signal defining a sequence of clock pulses. In an embodiment multiple subsets of elements are disjunct and each includes at least one element. An embodiment comprises determining, for a first clock pulse, elements in the subset to consume power associated with a second clock pulse. In particular, during the second clock pulse the elements in the subset can consume the power associated with the second clock pulse. In an embodiment the second clock pulse follows immediately upon the present clock pulse. An embodiment comprises controlling the power supply based on the determining elements to consume power. At least one effect can be that the power consumption by the plurality of elements can be held low as required to support operation of the elements.

In an embodiment, in the plurality of elements, each element includes a group of transistors. In an embodiment the group of transistors forms the respective element so as to include at least one flip-flop. In an embodiment the element is defined by a clock control unit for control of clock signal delivery to the element. In an embodiment the clock control unit includes a clock gate configured to switch delivery of the clock signal to the element on and off. In an embodiment the clock gate forms part of a clock tree and the element forms a clock branch in the clock tree that is associated with the clock gate. At least one effect can be that system control can be based on a power consumption known to occur in elements fed with the clock signal gated at the clock gate.

An embodiment comprises providing the power supply with a buffer, the buffer configured to have a capacitance commensurate with charge used in operation of the power supply. At least one effect can be that the buffer can accept charge and thus prevent current spikes from damaging circuitry. An embodiment comprises controlling the power supply to supply power up to the acceptable level of power consumption. At least one effect can be that the power consumption by the plurality of elements can be limited by the acceptable power consumption.

An embodiment comprises providing, for each element, an associated control signal for use in control of the power supply, the associated control signal being associated with the element. An embodiment comprises combining the associated control signal with a power contribution for consumption by the element. An embodiment comprises forming a combined control signal, the combined control signal to control the power supply. In an embodiment the associated control signal is provided as a digital signal. In an embodiment combining the associated control signal with the power contribution is a logical function. In an embodiment the combining is provided by at least one logic gate in a group of logic gates comprising AND, OR, and XOR. In an embodiment the combined control signal is a sum of weighted power contributions. In an embodiment the weighted power contributions are weighted by a number of clock branches associated with the clock gate.

This description, in an aspect according to some embodiments, describes an apparatus for use in a system, the system to include a plurality of elements and a power supply to supply power to the plurality of elements. An embodiment comprises a subset of elements in the plurality of elements. An embodiment comprises a clock signal delivery configured to deliver a clock signal to the subset of elements in the plurality of elements, the clock signal defining a sequence of clock pulses. An embodiment comprises a control module configured to determine, for a first clock pulse, elements in the subset to consume power associated with a second clock pulse. In an embodiment the control module is further configured to control the power supply based on the determining elements to consume power.

In an embodiment, in the plurality of elements, each element includes a group of transistors. In an embodiment the element is defined by a clock control unit for control of clock signal delivery to the element. In an embodiment the clock control unit includes a clock gate configured to switch delivery of the clock signal to the element on and off. In an embodiment the clock gate forms part of a clock tree and the element forms a clock branch in the clock tree that is associated with the clock gate. An embodiment comprises with each element a buffer, the buffer being configured to have a capacitance commensurate with an amount of charge used in operation of the power supply. In an embodiment the control module is further configured to control the power supply to supply power up to the acceptable level of power consumption. In an embodiment the control module is further configured to provide, for each element, an associated control signal for use in control of the power supply, the associated control signal being associated with the element. In an embodiment the control module is further configured to form a combined control signal, the combined control signal to control the power supply. In an embodiment the combined control signal is a sum of weighted power contributions.

This description in an aspect according to some embodiments describes a device for use in control of a system, the system to include a plurality of elements and a power supply to supply power to the plurality of elements. The device is configured to receive a clock signal associated with at least one subset of elements in the plurality of elements, the clock signal defining a sequence of clock pulses. The device is further configured to provide a control signal to the power supply based on determining, in a first clock pulse, the elements to consume power associated with a second clock pulse. In an embodiment, in the plurality of elements, each element includes a group of transistors. In an embodiment the element is defined by a clock control unit for control of clock signal delivery to the element. In an embodiment the clock control unit includes a clock gate configured to switch delivery of the clock signal to the element on and off. In an embodiment the clock gate forms part of a clock tree and the element forms a clock branch in the clock tree that is associated with the clock gate. An embodiment a buffer, the buffer configured to have a capacitance commensurate with charge used in operation of the power supply. In an embodiment the device is configured to control the power supply to supply power up to the acceptable level of power consumption. In an embodiment the device is configured to provide, for each element, an associated control signal for use in control of the power supply, the associated control signal being associated with the element, and is further configured to combine the associated control signal with a power contribution for consumption by the element.

This description in an aspect according to some embodiments describes a system for use in data processing. An embodiment comprises a plurality of elements including a subset of elements. An embodiment comprises a power supply to supply power to the plurality of elements. An embodiment comprises a clock signal delivery configured to deliver a clock signal to the subset of elements in the plurality of elements, the clock signal defining a sequence of clock pulses. An embodiment comprises, for a first clock pulse, elements in the subset to consume power associated with a second clock pulse. In an embodiment a control module configured to control the power supply based on the determining elements to consume power. In an embodiment the subset of elements comprises at least one storage element. According to some embodiments the storage element is configured to receive a signal to set the storage element to one state and to keep the one state until reception of another signal to set the storage element to another state—until reception of yet another signal to set the storage element to the one set. In an embodiment the storage element is provided as a flip-flop. In an embodiment, in the plurality of elements, each element includes a group of transistors. In an embodiment the element is defined by a clock control unit for control of clock signal delivery to the element. In an embodiment at least a portion of the system is provided as an integrated circuit.

The word ‘exemplary’ is used herein to mean serving as an example, instance, or illustration. Any aspect or design described herein as ‘exemplary’ is not necessarily to be construed as preferred or advantageous over other aspects or designs. Rather, use of the word exemplary is intended to present concepts and techniques in a concrete fashion. The term ‘techniques,’ for instance, may refer to one or more devices, apparatuses, systems, methods, articles of manufacture, and/or computer-readable instructions as indicated by the context described herein. “As used in this application, the term ‘or’ is intended to mean an inclusive ‘or’ rather than an exclusive ‘or.’ That is, unless specified otherwise or clear from context, ‘X employs A or B’ is intended to mean any of the natural inclusive permutations. That is, if X employs A. The articles ‘a’ and an as used in this application and the appended claims should generally be construed to mean one or more′, unless specified otherwise or clear from context to be directed to a singular form. For the purposes of this disclosure and the claims, the terms ‘coupled’ and ‘connected’ may have been used to describe how various elements interface. Such described interfacing of various elements may be either direct or indirect.

It is to be understood that the features of the various embodiments described herein may be combined with each other, unless specifically noted otherwise. Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. It is intended that this invention be limited only by the claims and the equivalents thereof. Exemplary implementations/embodiments discussed herein may have various components collocated. The implementations herein are described in terms of exemplary embodiments. However, it should be appreciated that individual aspects of the implementations may be separately claimed and one or more of the features of the various embodiments may be combined. In some instances, well-known features are omitted or simplified to clarify the description of the exemplary implementations. In the above description of exemplary implementations, for purposes of explanation, specific numbers, materials configurations, and other details are set fourth in order to better explain the invention, as claimed. However, it will be apparent to one skilled in the art that the claimed invention may be practised using different details than the exemplary ones described herein. Described exemplary embodiments/implementations herein are intended to be primarily examples. The order in which the embodiments/implementations and methods/processes are described is not intended to be construed as a limitation, and any number of the described implementations and processes may be combined. In particular regard to the various functions performed by the above described components (e.g., elements and/or resources), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. While a particular feature of the disclosure may have been disclosed with respect to only one of several implementations, such feature may be combined with one or more other features of the other implementations as may be desired and advantageous for any given or particular application.

Depending on certain implementation requirements, embodiments of the invention can be implemented in hardware or in software. In general, any apparatus capable of implementing a state machine that is in turn capable of implementing the methodology described and illustrated herein may be used to implement the various methods, protocols and techniques according to the implementations. The communication arrangements, procedures and protocols described and illustrated herein as well as variations thereof may be readily implemented in hardware and/or software using any known or later developed systems or structures, devices and/or software by those of ordinary skill in the applicable art from the functional description provided herein and with a general basic knowledge of the computer and telecommunications arts.

What is claimed is:

1. A method, for use in control of a system, the system to include a plurality of elements and a power supply to supply power to the plurality of elements, the method comprising:
delivering a clock signal to a subset of elements in the plurality of elements, the clock signal defining a sequence of clock pulses;
determining, for a first clock pulse, elements in the subset to consume power associated with a second clock pulse; and
controlling the power supply based on the determining elements to consume power.

2. The method of claim 1, wherein, in the plurality of elements, each element includes a group of transistors, wherein the element is defined by a clock control unit for control of clock signal delivery to the element.

3. The method of claim 2, wherein the clock control unit includes a clock gate configured to switch delivery of the clock signal to the element on and off.

4. The method of claim 1, further comprising:
providing the power supply with a buffer, the buffer configured to have a capacitance commensurate with charge used in operation of the power supply; and
controlling the power supply to supply power up to said acceptable level of power consumption.

5. The method of claim 1, further comprising:
providing, for each element, an associated control signal for use in control of the power supply, the associated control signal being associated with the element.

6. The method of claim 5, further comprising:
combining the associated control signal with a power contribution for consumption by the element; and
forming a combined control signal, the combined control signal to control the power supply.

7. The method of claim 6, wherein the associated control signal is provided as a digital signal, wherein combining the associated control signal with the power contribution is a logical function, wherein the combined control signal is a sum of weighted power contributions, and wherein the weighted power contributions are weighted by a number of clock tree branches associated with the clock gate.

8. An apparatus, for use in a system, the system to include a plurality of elements and a power supply to supply power to the plurality of elements, the apparatus comprising a subset of elements in the plurality of elements, a clock signal delivery configured to deliver a clock signal to the subset of elements in the plurality of elements, the clock signal defining a sequence of clock pulses, a control module configured to determine, for a first clock pulse, elements in the subset to consume power associated with a second clock pulse, wherein the control module is further configured to control the power supply based on the determining elements to consume power.

9. The apparatus of claim 8, wherein, in the plurality of elements, each element includes a group of transistors, wherein the element is defined by a clock control unit for control of clock signal delivery to the element.

10. The apparatus of claim 9, wherein the clock control unit includes a clock gate configured to switch delivery of the clock signal to the element on and off, wherein the clock gate forms part of a clock tree and the element forms a clock tree branch in the clock tree that is associated with the clock gate.

11. The apparatus of claim 8, further comprising with each element a buffer configured to have a capacitance commensurate with charge used in operation of the power supply, wherein the control module is further configured to control the power supply to supply power up to said acceptable level of power consumption.

12. The apparatus of claim 8, wherein the control module is further configured to provide, for each element, an associated control signal for use in control of the power supply, the associated control signal being associated with the element.

13. The apparatus of claim 12, wherein the control module is further configured to form a combined control signal, the combined control signal to control the power supply, wherein the combined control signal is a sum of weighted power contributions.

14. A device, for use in control of a system, the system to include a plurality of elements and a power supply to supply power to the plurality of elements,
wherein the device is configured to receive a clock signal associated with at least one subset of elements in the plurality of elements, the clock signal defining a sequence of clock pulses, and
wherein the device is further configured to provide a control signal to the power supply based on determining, in a first clock pulse, the elements to consume power associated with a second clock pulse.

15. The device of claim 14, wherein, in the plurality of elements, each element includes a group of transistors, wherein the element is defined by a clock control unit for control of clock signal delivery to the element.

16. The device of claim 15, wherein the clock control unit includes a clock gate configured to switch delivery of the clock signal to the element on and off, and wherein the clock gate forms part of a clock tree and the element forms a clock tree branch in the clock tree that is associated with the clock gate.

17. The device of claim 14, further comprising a buffer configured to have a capacitance commensurate with charge used in operation of the power supply, wherein the device is configured to control the power supply to supply power up to said acceptable level of power consumption.

18. The device of claim 14, wherein the device is configured to provide, for each element, an associated control signal for use in control of the power supply, the associated control signal being associated with the element, and is further configured to combine the associated control signal with a power contribution for consumption by the element.

19. A system, for use in data processing, the system comprising:
a plurality of elements including a subset of elements;
a power supply to supply power to the plurality of elements;
a clock signal delivery configured to deliver a clock signal to the subset of elements in the plurality of elements; and
a control module configured to control the power supply based on the determining elements to consume power,
wherein the clock signal defining a sequence of clock pulses, and, for a first clock pulse, elements in the subset to consume power associated with a second clock pulse.

20. The system of claim 19, wherein, in the plurality of elements, each element includes at least one flip-flop.
